(19) United States
(12) Patent Application Publication
(10) Pub. No.: US 2022/0034632 A1
(43) Pub. Date: Feb. 3, 2022

(54) A Reinforced Armor And A Process For Reinforcing An Armor By Composite Layering

(71) Applicant: Global Metallix Canada Inc., Vancouver (CA)

(72) Inventors: Jack J. MASSARELLO, Ottawa (CA); Robert A. SOTELO, Folsom, CA (US); Zachary B. SPENCER, Sacramento, CA (US); Brian E. SPENCER, Sacramento, CA (US); Andrew H. WEISBERG, San Francisco, CA (US)

(73) Assignee: Global Metallix Canada Inc., Vancouver, BC (CA)

(21) Appl. No.: 17/299,723

(22) PCT Filed: Dec. 3, 2019
(86) PCT No.: PCT/CA2019/051737

§ 371 Date: Jun. 3, 2021

Related U.S. Application Data
(60) Provisional application No. 62/775,264, filed on Dec. 4, 2018.

(51) Int. Cl. F41H 5/04; B32B 5/26; B32B 15/18; B32B 15/14; B32B 38/18; B32B 5/12; B32B 37/06; B32B 38/00

(52) U.S. Cl. CPC F41H 5/0471; F41H 5/0435; F41H 5/0464; B32B 5/26; B32B 15/18; B32B 2571/02; B32B 38/1808; B32B 5/12; B32B 37/06; B32B 38/0004; B32B 15/14

(57) ABSTRACT

A reinforced armor (200) and a process for reinforcing an armor by composite layering are provided. The reinforced armor (200) includes a core structure having a strike face and a back face, a first composite fiber laminate (220) having a plurality of composite fiber plies, bonded to the strike face of the core structure, and a second composite fiber laminate (225) having a plurality of composite fiber plies, bonded to the back face of the core structure. The process for reinforcing the armor includes creating the first and second composite fiber laminates from a plurality of plies of fibrous material impregnated with a resin matrix, and bonding the first and second composite fiber laminate to both the strike face and the back face. Advantageously, the reinforced armor (200) is capable of providing protection against hazards while having a light weight compared with a rigid armor such as steel or ceramic.

### TECHNICAL FIELD

The present disclosure relates generally to armor and more specifically to a reinforced armor and a process for reinforcing an armor by composite layering.

### BACKGROUND

Armor plates, also known as impact resistant plates, or simply armor offer protection for people, animals, and valuables from threats such as impact, ballistic projectiles, and construction debris. Armor plates may be used in body armor, stationary armor, or vehicle armor. To eliminate or reduce penetration of their surfaces armor plates are manufactured from hard projectile-resistant materials such as metals, alloys and ceramics.

The National Institute of Justice (NIJ) is the research, development and evaluation energy of the U.S. Department of Justice. The NIJ has different classifications, or levels, of armor based on the type of threat that the armor can stop. For example, an NIJ Level II armor can stop different projectiles but may not stop a Magnum 44 projectile or projectiles that are more powerful. An NIJ Level III armor, however, can stop all types of projectiles except for armor piercing ones.

In order to provide adequate protection against hazards, the thickness of an armor plate is increased. For example, while a Level II armor plate typically has a thickness of 5 mm, a Level III armor typically has a thickness of around 15 mm. The increased armor thickness results in an increased mass of the armor plate. The increased mass causes a decrease in physical dexterity as vehicles and personnel utilizing the armor plate are heavier and less mobile. For vehicles, the increased mass contributes to mechanical inefficiency and engines that are more powerful are needed to power the vehicles with the heavier armor plates. For personnel, the heavier armor makes them less mobile and harder to extract from a hazardous situation.

### SUMMARY

In one aspect of the present disclosure, there is provided a reinforced armor comprising a core structure, a first composite fiber laminate, and a second composite fiber laminate. The core structure has a strike face and a back face. The first composite fiber laminate comprises a first plurality of composite fiber plies bonded to the strike face of the core structure. The second composite fiber laminate comprises a second plurality of composite fiber plies bonded to the back face of the core structure. Each composite fiber ply of the first and second plurality of composite fiber plies is comprised of a fibrous material impregnated with a matrix material.

In one embodiment, the reinforced armor further comprises comprising a first bonding layer between the first composite fiber laminate and the strike face of the core structure, and a second bonding layer between the second composite layer and the back face of the core structure. In one embodiment, the first bonding layer and the second bonding each comprises an adhesive selected from the group consisting of: epoxy resin adhesive, urethane adhesive, film adhesive, and liquid adhesive paste.

In one embodiment, the core structure comprises a core plate made from a material selected from the group consisting of: steel, ceramic, titanium, silicon carbide, metal matrix composites, cermets, polymer matrix composites, and Inconel alloys. In one embodiment, the steel is selected from the group consisting of: abrasion resistant (AR) steel, stainless steel, mild steel, and duplex stainless steel. In one embodiment, the ceramic is one of: alumina, silicon nitride, boron nitride, porcelain, and silicon carbide.

In one embodiment, at least some composite fiber plies of the first and second plurality of composite fiber plies are oriented at different orientation angles relative to a latitudinal axis of the core structure. In one embodiment, the different orientation angles vary between 0 and +/−90 degrees.

In one embodiment, the second plurality of composite fiber plies has more composite fiber plies than the first plurality of composite fiber plies.

In one embodiment, at least one of the first and second plurality of composite fiber plies comprises composite fiber plies comprising different types of fibrous materials

In one embodiment, the matrix material comprises a polymer resin selected from the group consisting of: epoxy resin, vinyl ester, and Polydicyclopentadiene (PDCPD).

In one embodiment, the fibrous material is one of fiberglass, carbon fiber, aramid fiber, plastic fiber, and metallic fiber.

In one embodiment, the core structure comprises a first core plate, a central composite fiber laminate, and a second core plate. The first core plate has a strike face and a back face. The central composite fiber laminate has a strike face bonded to the back face of the first core plate, and has a back face. The second core plate has a strike face bonded to the back face of the central composite fiber laminate and has a back face.

In one embodiment, the core structure comprises a core plate having a plurality of perforations. In one embodiment, the plurality of perforations are filled with one of: an elastomer, an adhesive, epoxy resin, and PDCPD.

In another aspect of the present disclosure, there is provided a process for reinforcing an armor by composite layering. The process comprises stacking a plurality of composite fiber plies using hand lay-up to create wet composite fiber laminate, placing the wet composite fiber laminate on at least one surface of a core plate of the armor, subjecting the wet composite fiber laminate and core plate to heating, allowing the core plate and wet composite fiber laminate to co-cure, and cutting the composite fiber laminate to a desired length.

In one embodiment, the process further comprises preparing the at least one surface of the core plate by at least one of: sandblasting, cleaning by a cleaning solvent, and applying an etchant.

In one embodiment, stacking the plurality of composite fiber plies comprises orienting the composite fiber plies at different orientation fiber angles.

In yet another aspect of the present disclosure there is provided another process for reinforcing an armor. The process comprises stacking a plurality of fiber plies, on a caul plate, using hand lay-up to create a fiber laminate; vacuum bagging the fiber laminate; placing the caul plate and fiber laminate in an oven and heating the caul plate and fiber laminate; curing the fiber laminate to form a rigid fiber laminate plate; demolding the rigid fiber laminate plate from the caul plate, and cutting it to a desired length; applying bonding material to at least one surface of a core plate of the armor; and placing the rigid fiber laminate plate on the last least one face for bonding thereto.

In one embodiment, each ply of the plurality of fiber plies comprises a fibrous material impregnated with a matrix material, the fiber laminate comprises a wet composite fiber laminate, and the rigid fiber laminate plate comprises a rigid composite fiber laminate plate

In one embodiment, each ply of the plurality of fiber plies comprises a dry fibrous material, the fiber laminate comprises a dry fiber laminate, and the rigid fiber laminate plate comprises a rigid composite fiber laminate plate. In this embodiment, the process further comprises using vacuum to draw a resin matrix into the dry fiber laminate to create a wet composite fiber laminate, prior to placing the caul plate and the wet composite fiber laminate in the oven.

In one embodiment, the process further comprises preparing the at least one surface of the core plate by at least one of: sandblasting, cleaning by a cleaning solvent, and applying an etchant.

In one embodiment, the process further comprises comprising at least one of: cutting, machining, grinding, and polishing of the rigid fiber laminate plate prior to bonding the rigid fiber laminate plate to the core plate.

In one embodiment, stacking the plurality of composite fiber plies comprises orienting the composite fiber plies at different orientation fiber angles.

### BRIEF DESCRIPTION OF THE DRAWINGS

In the accompanying drawings:

FIG. 1A is a front elevation view of a prior art armor plate showing a strike face;

FIG. 1B is a side elevation view of the prior art armor plate of FIG. 1A;

FIG. 1C is a perspective of the prior art armor plate of FIG. 1A;

FIG. 2A is a front elevation view of a reinforced armor plate showing a strike face comprising a first composite laminate;

FIG. 2B is a side elevation view of the reinforced armor plate of FIG. 2A showing a core plate, the first composite laminate bonded to the strike face of the core plate to form the strike face of the reinforced armor plate, and a second composite laminate bonded to the back face of the core plate to form the back face of the reinforced armor plate;

FIG. 2C is a perspective view of the reinforced armor plate of FIGS. 2A and 2B;

FIG. 3A is a front elevation view of a reinforced armor plate showing a strike face comprising a first composite laminate;

FIG. 3B is a side elevation view of the reinforced armor plate of FIG. 3A showing a core plate, the first composite laminate bonded to the strike face of the core plate by means of a first layer of adhesive sandwiched therebetween, and a second composite laminate bonded to the back face of the core plate by means of a second layer of adhesive sandwiched therebetween;

FIG. 4A is a front elevation view of a reinforced armor plate showing a strike face including a composite laminate;

FIG. 4B is a side elevation view of the reinforced armor plate of FIG. 4A showing a first central composite laminate, a first core plate bonded to the strike face of the first central composite laminate, a second composite laminate bonded to the strike face of the first core plate, a second core plate bonded to the back face of the first central composite laminate, and a third composite laminate bonded to the back face of the second core plate;

FIG. 5A is a front elevation view of a reinforced armor plate showing a strike face including a composite laminate

FIG. 5B is a side elevation view of the reinforced armor plate of FIG. 5A showing a central composite laminate, a first core plate bonded to the strike face of the central composite laminate by a first adhesive layer, a first composite laminate bonded to the strike face of the first core plate by a second adhesive layer, a second core plate bonded to the back face of the first central composite laminate by a third adhesive layer, and a second composite laminate bonded to the back face of the second core plate by a fourth adhesive layer;

FIG. 6A and FIG. 6B show a light weight perforation pattern typically used an armored steel plate;

FIG. 7 is a perspective view of the back face of steel plate, showing a deformation as a result of an impact test;

FIG. 8 is a perspective view of the back face of composite-reinforced steel plate sample, showing a deformation as a result of an impact test;

FIG. 9 depicts a process for reinforcing an armor by composite layering, in accordance with an embodiment of the present disclosure; and

FIG. 10 depicts a process for reinforcing an armor by composite layering, in accordance with another embodiment of the present disclosure; and

FIG. 11 depicts a process for reinforcing an armor by composite layering, in accordance with yet another embodiment of the present disclosure.

Some of the drawings are not drawn to scale but have been enlarged in certain dimensions to emphasize and clarify certain features. For example, the thickness of the armor plates in, comparison with other dimensions has been exaggerated to show the different layers comprising the armor plate.

### DETAILED DESCRIPTION

Directional terms such as “top,” “bottom,” “upwards,” “downwards,” “left,” “right,” “vertically,” and “laterally” are used in the following description for the purpose of providing relative reference only, and are not intended to suggest any limitations on how any article is to be positioned during use, or to be mounted in an assembly or relative to an environment. The use of the word “a” or “an” when used herein in conjunction with the term “comprising” may mean “one,” but it is also consistent with the meaning of “one or more,” “at least one” and “one or more than one.” Any element expressed in the singular form also encompasses its plural form. Any element expressed in the plural form also encompasses its singular form. The term “plurality” as used herein means more than one; for example, the term “plurality includes two or more, three or more, four or more, or the like.

In this disclosure, the terms “comprising”, “having”, “including”, and “containing”, and grammatical variations thereof, are inclusive or open-ended and do not exclude additional, un-recited elements and/or method steps. The term “consisting essentially of” when used herein in connection with a composition, use or method, denotes that additional elements, method steps or both additional elements and method steps may be present, but that these additions do not materially affect the manner in which the recited composition, method, or use functions. The term “consisting of” when used herein in connection with a composition, use, or method, excludes the presence of additional elements and/or method steps.

In this disclosure, the terms “armor” and “armor plate” are used interchangeably, and refer to a protective covering that is used to prevent damage from being inflicted on an object, individual or vehicle by direct contact weapons or projectiles. The armor may also protect against damage caused by a potentially dangerous environment or activity. The shape of an armor or an armor plate is non-limiting.

In this disclosure, the term “strike face” refers to the side or surface of an armor, which is directed towards the approach path of a hazard or an incoming projectile. A “back face” refers to the opposite side of an armor plate as the strike face. An incoming projectile is first received by the strike face and may penetrate the armor and exit from the back face.

In this disclosure, the term “core structure” refers to a central main structural component of an armor or an armor plate. A core structure may comprise one or more than one core plates and may comprise other layers of materials. A core structure is typically made of hard materials such as metal, metal alloy, or ceramic. In this disclosure, the terms “core armor plate”, “core armor”, and “core plate” are examples of a “core structure”.

In this disclosure, the terms “spalling” and more specifically “metal spalling” refer to a process of metallic surface failure in which a metal is broken down into small flakes (spalls) from a larger solid body.

In this disclosure, the term “fiber” or “fibrous material” refers to a substance that is significantly longer than it is wide. The term “dry fiber” refers to a fiber or fibrous material, which has not been impregnated with a matrix material.

In this disclosure, the term “matrix” or “resin matrix” refers to a polymer resin material, which is used to impregnate a fiber in a fibrous composite material.

In this disclosure, the terms “composite”, “composite material”, “composite fiber”, and “fibrous composite material”, refer to a material consisting of two different materials bonded together. One material is a fibrous material and the other is a matrix material used to impregnate the fibrous material thus creating a composite material having increased strength and stiffness. The fibers may be unidirectional, woven or random chopped.

In this disclosure, a “prepreg” refers to a reinforcing fabric, which has been pre-impregnated with a resin system. The resin system used includes a proper curing agent.

Hence, the prepreg is ready to lay into the mold without the addition of any more resin.

In this disclosure, the term “composite fiber laminate” refers to an assembly of layers (or plies) of fibrous composite materials which can be joined to provide required engineering properties. The layers consist of high-modulus fibers impregnated with a matrix material.

In this disclosure, a “cermet” refers to a class of heat-resistant materials made of ceramic and sintered metal.

In the various figures, the same references denote identical or similar elements.

Addressing the challenges identified in the Background, the present disclosure provides a reinforced armor suitable for protecting: a person at risk; a land, sea, air, or space vehicle; or any valuable stationary asset. The reinforced armor provides protection against extreme conditions, such as the ballistic hazards of combat or combat-like occurrences.

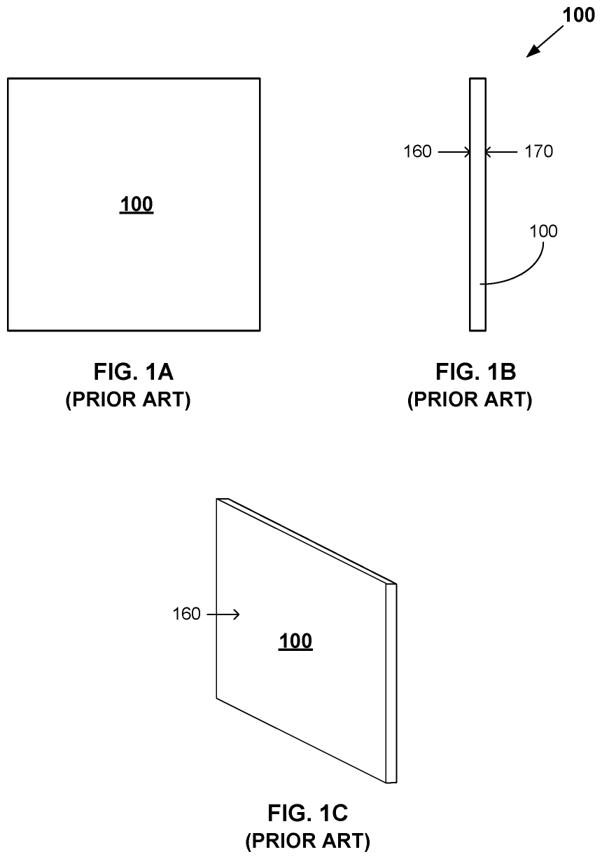

FIGS. 1A, IB and 1C (collectively “FIG. 1”) shows a prior art armor plate 100. One example of such prior art armor plate is an AR-500 steel armor plate. The armor plate 100 shown is of square shape. The armor plate 100 may have a side of 12 inches, and a thickness of 0.19 inches. Other sizes, shapes, and thicknesses are also available. The prior art armor plate 100 has a strike face 160 which is hazard facing, and a back face 170 opposite the strike face 160.

The prior art armor plate of FIG. 1 is used for comparative ballistic testing. For example, the various embodiments of the armor plate presented in this disclosure have been subjected to Level III NIJ testing, and the results have been compared with the same tests performed on the prior art armor plate 100 of FIG. 1. The comparative ballistic tests have been carried out on prior art armor plates such as armor plate 100, made of AR-500 steel, AR-600 steel, stainless steel, and mild steel. Additionally, the ballistic tests have been conducted on exotic steels such as Inconel steel and Duplex stainless steel. In order to enhance the impact resistance of a traditional armor plate such as armor plate 100, the thickness is typically increased. However, increasing the thickness adds to the mass of the armor plate, which is undesirable as discussed above.

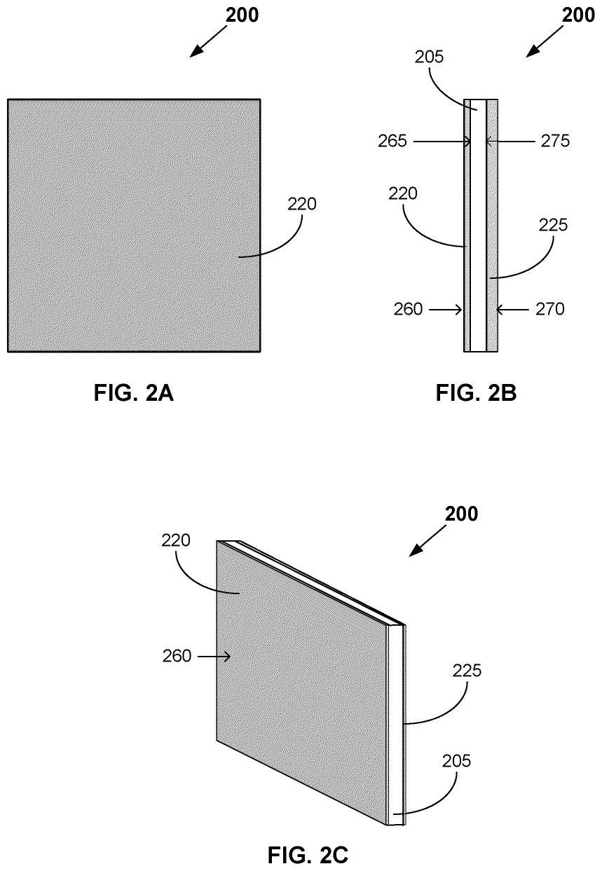

In one aspect present disclosure, there is provided a reinforced armor, such as a reinforced armor plate. FIGS. 2A-2C (collectively “FIG. 2”) depict a reinforced armor plate 200, in accordance with an embodiment of the present disclosure, which addresses at least some of the aforementioned challenges. The reinforced armor plate 200 comprises a core structure such as the core plate 205. The core plate 205 has a strike face 265 and a back face 275. A first composite fiber laminate 220 is bonded to the strike face 265 of the core plate 205. The composite fiber laminate 220 forms the strike face 260 of the reinforced armor plate 200. Similarly, a second composite fiber laminate 225 is bonded to the back face 275 of the core plate 205, and the second composite fiber laminate 225 forms the back face 270 of the reinforced armor plate 200. In the embodiment of FIG. 2, the first composite fiber laminate 220 and the second composite fiber laminate 225 are co-cured with the core plate 205. As a result, the composite fiber laminate 220 bonds to the strike face 265 of the core plate 205, and the composite fiber laminate 225 bonds to the back face 275 of the core plate.

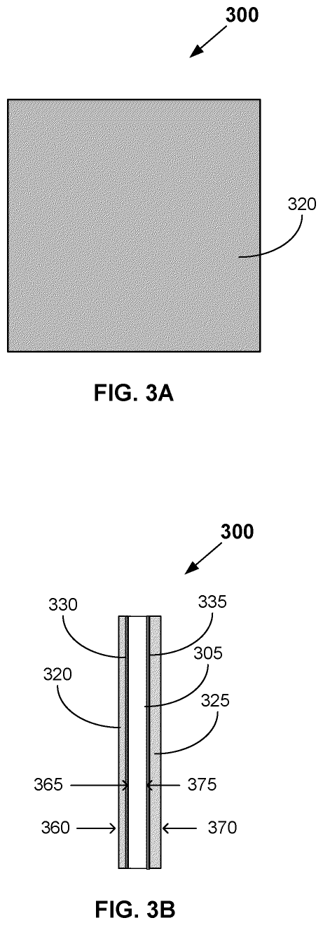

FIGS. 3A-3B (collectively “FIG. 3”) depict a reinforced armor plate 300 in accordance with another embodiment of the present disclosure. The reinforced armor plate 300 comprises a core plate 305 similar to that of FIG. 2. The core plate 305 has a strike face 365 and a back face 375. A first composite fiber laminate 320 is bonded to the strike face 365 of the core armor plate 305 by means of a first bonding layer 330 sandwiched between the strike face 365 of the core plate 305 and the first composite fiber laminate 320. The composite fiber laminate 320 forms the strike face 360 of the reinforced armor plate 300. Similarly, a second composite fiber laminate 325 is bonded to the back face 375 of the core plate 305 by means of a second bonding layer 335 sandwiched between the back face 375 of the core armor plate 305 and the composite fiber laminate 325. The composite fiber laminate 325 forms the back face 370 of the reinforced armor plate 300. The first bonding layer 330 and the second bonding layer 335 each comprises an adhesive. In one embodiment, the adhesive is an epoxy resin adhesive. In other embodiments, the adhesive may be a urethane adhesive, a film adhesive, or a liquid adhesive paste.

In one embodiment, that core plate 305 is made of steel. In other embodiments, the core plate may be made of ceramic, titanium, silicon carbide, metal matrix composites cermets, polymer matrix composites, or Inconel alloys. In one embodiment, the steel is an abrasion resistant (AR) steel such as AR-500 or AR-600 steel. In other embodiments, the core plate may be stainless steel, mild steel, or duplex stainless steel. The ceramic may be alumina, silicon nitride, or silicon carbide. In a preferred embodiment, AR-500 is used for the core plate since it is cost-effective and because it offers some of the best results in terms of weight efficiency. In other embodiments, types of steels may be used in applications that are not weight-sensitive, as is the case with stationary armor.

The first composite fiber laminate 320 is comprised of a first plurality of composite fiber plies. The second composite fiber laminate 125 is comprised of a second plurality of composite fiber plies. Each composite fiber ply is comprised of a fibrous material impregnated with a matrix material. At least some composite fiber plies of the first and second plurality of composite fiber plies are oriented at different orientation angles relative to a latitudinal axis of the core plate 100. The different orientation angles vary between 0 and +/−90 degrees. The choice of angle depends on the anticipated type of hazard that the armor will be subjected to. It is expected that orienting at 0-90, +/−45, and/or +/−30 degree combinations would enhance anisotropic properties and overall performance of the armor. For example, altering the fiber orientation angle above or below 45 degrees will increase or reduce the final composite fiber laminate plate performance characteristics under ballistic impact loading conditions. As a result, changing or varying the fiber angle allows significant variability in the laminate properties for a final geometry. Fibers oriented in the third “Z” direction, i.e. fibers normal to the latitudinal plane of the respective plate, also offer significant variability and tailoring options in the final laminate properties.

In some embodiments, the number of composite fiber plies in the second composite fiber laminate 125 bonded to the back face 170 is greater than the number of plies in the first composite fiber laminate 120 bonded to the strike face 160. For example, ballistic tests have shown that bonding three composite fiber plies on the strike face and bonding seven composite fiber plies on the back face give favorable results.

The fibrous material used in the composite fiber plies is comprised of a plurality of fibers. In one embodiment, the plurality of fibers comprise carbon fiber. In another embodiment, the plurality of fibers comprise fiberglass. In yet other embodiments, the fibers may comprise aramid fibers, plastic fibers, or metallic fibers. In yet another embodiment, the plurality of fibers comprise Kevlar® developed by DuPont. In a further embodiment, the plurality of fibers comprise Zylon® developed by Stanford Research Institute (SRI). The fibrous material may comprise unidirectional or woven fibers.

In some embodiments, for body armor applications, the preferred fibrous material may be carbon fiber particularly for applications where higher modulus, strength and strain rate properties are required. Specifically, as carbon fiber is available with different modulus and strength properties, the control of a composite laminate plate's resistance to high-speed impact loading can be achieved by varying the carbon fiber starting material and/or fiber angles and number of ply layers.

In some embodiments, the preferred fibrous material is fiberglass. Fiberglass is generally heavier than carbon fiber and is lower in modulus and strength. Accordingly, composite fiber laminates where the fibrous material comprises fiberglass could be used in commercial applications such as vehicles where weight considerations may be of lesser concern when taking into consideration budget and desired protection ratings.

The matrix material used to impregnate the fibrous material is a polymer matrix. In one embodiment, the polymer matrix material used to impregnate the plurality of fibers of the composite fiber plies comprises epoxy resin. In another embodiment, the polymer matrix material comprises vinyl ester. In yet another embodiment, the polymer matrix material used is high purity dicyclopentadiene DCPD (also known as Polydicyclopentadiene or “PDCPD”). The amount of matrix material in the composite could be as high as 80% by volume.

In one embodiment, the first composite fiber laminate 120 used to reinforce the core plate 100 on the strike face 160, and the second composite fiber laminate 125 used to reinforce the core plate 100 on the back face 170 are each comprised of plies of standard weave carbon fiber impregnated with epoxy resin. The composite fiber laminate plies are oriented at 0 to 90 degrees relative to the latitude axis of the core plate. The epoxy resin content is no more than 50%. The composite fiber laminate plies of carbon fibers before cure are approximately 0.01 inches thick.

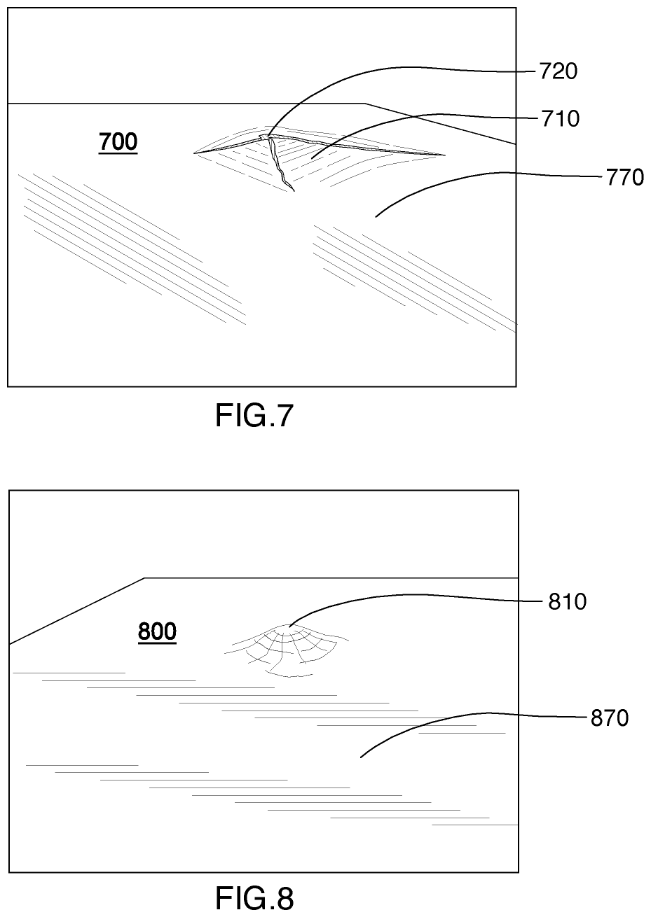

Advantageously, the incorporation of the composite fiber laminate to a steel core plate reduces spalling of the steel impact surface thus preventing injury or damage to surfaces normal to and in proximity to the strike face. Reference is made to FIGS. 7 and 8. FIG. 7 is a perspective view of the back face 770 of a 0.1875 thick AR-500 raw steel plate 700, showing the results of an impact test on the plate. The impact of the projectile on the steel plate 700 is a deformation 710 of the surface of the back face 770 and cracks 720 indicating that the metal has broken down potentially causing spalling.

FIG. 8 is a perspective view of the back face 870 of a reinforced armor 800 comprising a 0.1875 think AR-500 raw steel plate similar to the one used in the previous test of FIG. 7, but reinforced with composite fiber laminate, in accordance with an embodiment of the present disclosure. The reinforced armor 800 has a first composite fiber laminate having a thickness of 0.03 inches bonded to the strike face, and a second composite fiber laminate having a thickness of 0.06 inches bonded to the back face and forming a back face 870 of the reinforced armor 800. The first composite fiber laminate is comprised of three plies of pre-impregnated carbon fiber laminate, while the second composite fiber laminate is comprised of six plies of pre-impregnated carbon fiber laminate. The first and second composite fiber laminates and the core steel plate were co-cured to bond the laminates to the strike face and back face. FIG. 8 shows that the same impact test that caused both a deformation 710 and cracks 720 on a raw steel plate caused only a deformation 810 on the reinforced steel plate. Advantageously, the use of the composite armor laminate eliminates cracking and fracture of the steel surface thus reducing spalling.

It has been found, in the majority of impact tests that the thickness of the composite laminate on the strike face of the core structure did not have a material effect on the test result. However, the thickness of the composite laminate on the back face seemed to enhance performance as it is increased.

Advantageously, incorporating the composite fiber laminate into the armor enhances impact performance. This allows for the reduction of the thickness and weight of the core structure. Since a core structure is typically made of heavy materials such as steel or ceramic, reducing the thickness and weight of the core structure required improves mobility and reduces wear and tear on vehicle drivetrain for example. Furthermore, impact testing has also shown a reduction of back face deformation and the elimination of spalling, thus improving the overall performance, durability, and longevity of the armor.

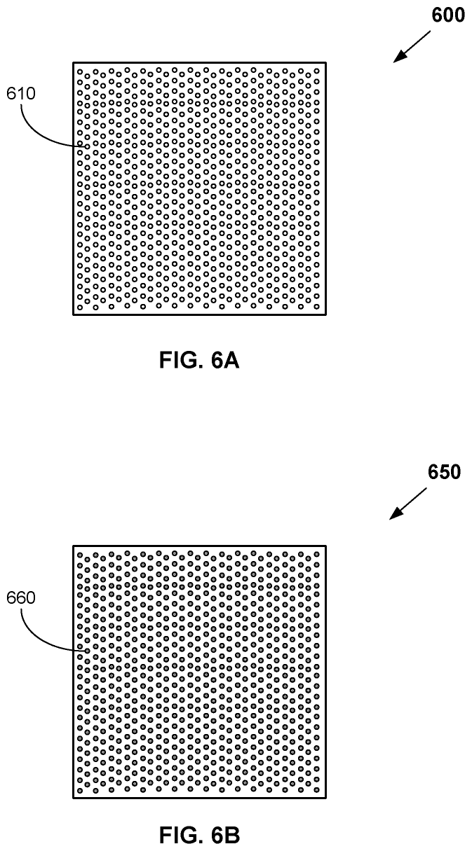

Another approach used to reduce the weight of the core structure is perforation. A plurality of perforations are formed in the core plate, which is made of a heavy material such as steel or ceramic. FIG. 6A depicts a perforated core plate 600 having a plurality of perforations 610 aimed at reducing the weight thereof for a less overall weight of the armor. The steel is perforated by using a drill, water jet, or laser-cutting machine. In one embodiment, the perforations 610 are less than the diameter of the expected projectile by 50%. FIG. 6B depicts a similar perforated core plate 650 wherein the perforations 660 are filled with supplemental materials, such as elastomer, adhesive, epoxy or PDCPD, depending on the prescribed protection requirements. While the use of perforations reduces the weight, it does not provide for good encapsulation of an incoming bullet for example, and does not eliminate the problem of spalling. It is therefore preferred that a perforated core plate be used in conjunction with a first composite fiber laminate bonded to the strike face thereof, and a second composite fiber laminate bonded to the back face thereof.

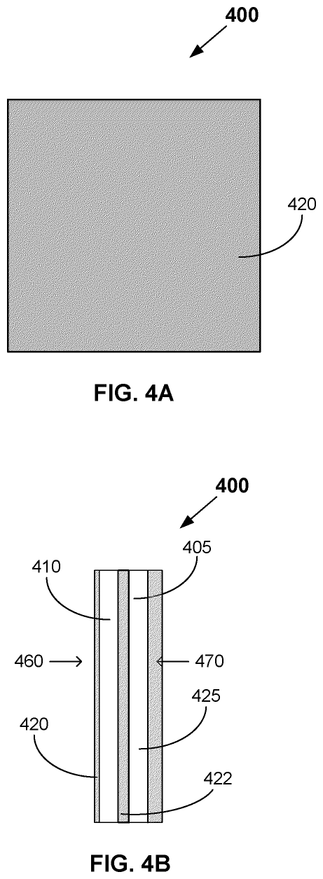

FIGS. 4A-4B (collectively “FIG. 4”) depict another embodiment of the present disclosure in which multiple core plates and multiple composite laminates are used. A reinforced armor 400 is shown. The reinforced armor 400 has a core structure, which is comprised of a first core plate 410 having a strike face and a back face. A central composite fiber laminate 422 has a strike face, which is bonded to the back face of the first core plate 410, and has a back face. A second core plate 405 has a strike face bonded to the back face of the central composite fiber laminate 422. The reinforced armor 400 has a first composite fiber laminate 420 bonded to the strike face of the first core plate 410, and provides a strike face 460 for the reinforced armor 400. The reinforced armor 400 has a second composite fiber laminate 425 bonded to the back face of the second core plate 405, and provides a back face 470 for the reinforced armor 400.

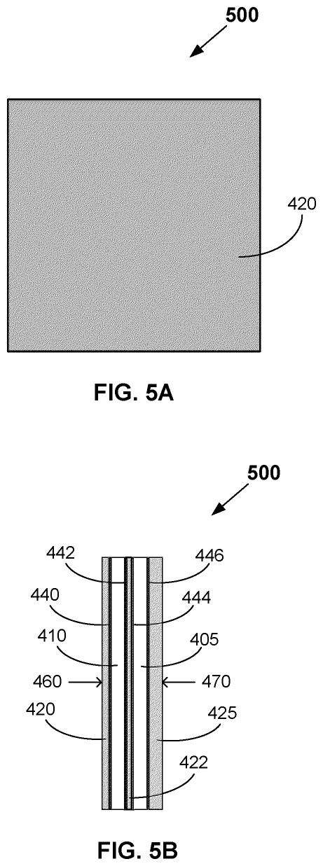

FIGS. 5A-5B (collectively “FIG. 5”) depict a similar embodiment to that shown in FIG. 4.

The armor 500 has a similar structure to armor 400 of FIG. 4 but includes bonding layers between the various components. A bonding layer 440 is sandwiched between the first composite fiber laminate 420 and the first core plate 410 for adhering them to one another. A bonding layer 442 is sandwiched between the first core plate 410 and the central composite fiber laminate 422 for adhering them to one another. A bonding layer 444 is sandwiched between the central composite fiber laminate 422 and the second core plate 405. A bonding layer 446 is sandwiched between the second core plate 405 and the second composite fiber laminate 425.

As shown in FIGS. 4B and 5B, the first composite laminate 420 bonded to the strike face has a smaller thickness and fewer composite fiber plies than the central composite fiber laminate 422. Similarly, the central composite fiber laminate 422 has a smaller thickness and fewer composite fiber plies than the second composite fiber laminate 425 bonded to the back face. This is consistent with the findings of the above-mentioned tests. This gradient layering of materials changes the load path as the projectile penetrates the plate. Advantageously, the weight of the armor can be reduced by incorporating thinner steel plates with alternating layers of composite laminates. This embodiment may be referred to as a layered strike plate.

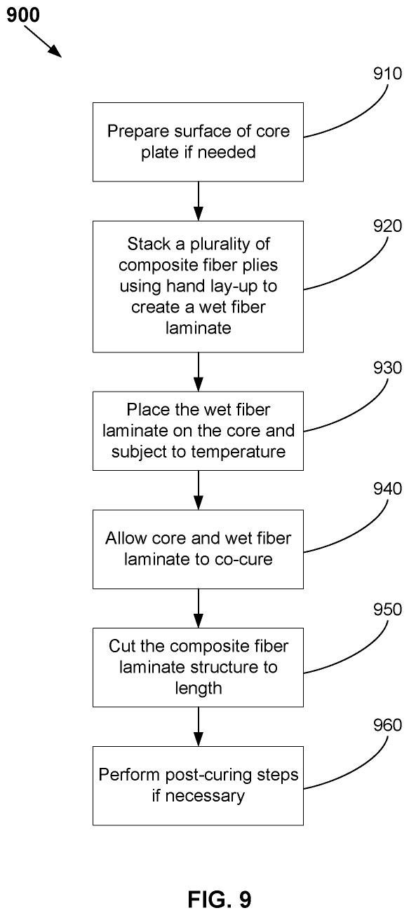

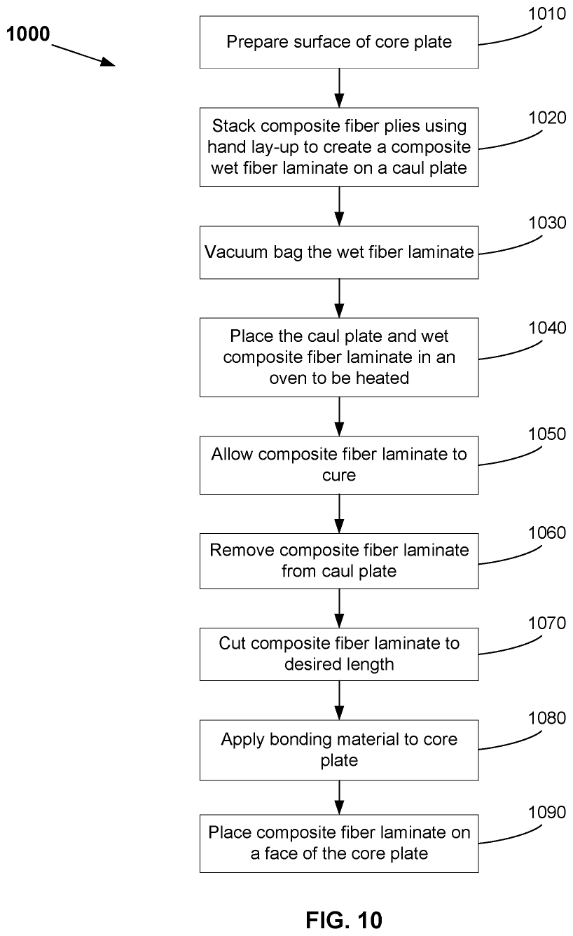

In one embodiment, the reinforced armor used as a test panel in the impact tests was prepared by co-curing a steel core plate and the composite fiber laminate plies under vacuum with a layer of film adhesive. The film adhesive used had a thickness of about 0.01 inches approximately, and was a standard epoxy type resin. The vacuum pressure used was a minimum of 22 inches of mercury and the maximum curing temperature was 275 degrees Fahrenheit. In another embodiment, the reinforced armor used as a test panel in the impact tests was prepared by bonding pre-cured composite fiber laminate to the steel core plate. Bonding agents such as film adhesive and liquid adhesive pastes have been used. FIGS. 9-10 depict various processes used to prepare a reinforced armor in accordance with embodiments of the present disclosure.

FIG. 9 depicts the steps of a process 900 for reinforcing an armor by composite layering, in accordance with an embodiment of the current disclosure. At step 910, the surface of the core plate of the armor is prepared, if needed. The core armor plate may have been provided in a condition where it is ready to be reinforced. Otherwise, the surface needs to be prepared using a series of surface treatment techniques. The surface treatment techniques include sandblasting, cleaning with an industrial grade cleaning solvent, and surface treatment with and etchant, as needed. Surface preparation extends both the shelf life and operational life of the armor. Proper surface treatment of the core eliminates premature failure modes that may arise from corrosion. Surface preparation also optimizes the composite fiber laminate bonding to the strike face and back face of the core plate.

At step 920, a plurality of resin-impregnated composite fiber plies are stacked, using hand-layup techniques, at different orientation angles to create a wet composite fiber laminate. At step 930, the wet composite fiber laminate is placed on the core structure of the armor, such as a core plate. The core plate and the wet composite fiber laminate are both subjected to temperature. At step 940, the core plate and the wet fiber laminate are allowed to co-cure. The co-curing causes the composite fiber laminate to bond to a face of the core plate, such as the strike face or the back face. This process is repeated for both the strike face and the back face of the core plate. At step 950, the composite fiber laminate is cut to desired length. At step 960, other post-curing steps such as machining are performed if needed.

FIG. 10 depicts the steps of a process 1000 for reinforcing an armor by composite layering, in accordance with an embodiment of the current disclosure. In this process, the composite fiber laminates are cured independent of the core armor plate. At step 1010, the surface of the core is prepared if necessary, as described before with respect to step 910 of process 900. At step 1020, a plurality of composite fiber plies are stacked on a metal caul plate. The composite fiber plies are stacked using hand lay-up techniques at different orientation angles to create a wet composite fiber laminate. The metal caul plate is preferably of aluminum construction and serves as a mandrel to ensure that the initial layers of fiber plies are laid down squarely and consistently, particularly important if woven roving fiber ply mats or pre-impregnated fiber sheets are used. The caul plate may be flat or curved, depending on the desired final geometry of the armor product. Layup techniques are used to ensure the fiber to resin matrix volume ratios are approximately 50%. The fiber angles may be varied from approximately 0 to 90 degrees as desired. Multiple composite fiber plies of different moduli and strength may be utilized in different laminates or within the same laminate.

At step 1030, the wet composite fiber laminate is vacuum bagged. The lay-up is completed and the wet composite fiber laminate is placed inside a bag made of flexible film and all the edges are sealed. The bag is then evacuated, so that the pressure eliminates voids in the wet composite fiber laminate forcing excess air and resin from the mold. At step 1040, the caul plate and composite fiber laminate are placed in an oven and heated as necessary. At step 1050, the composite fiber laminate is cured at an appropriate temperature to form a rigid composite fiber laminate plate. In one embodiment, the vacuum bagging and curing steps are done together in a temperature-controlled oven under vacuum.

At step 1060, after curing, the rigid composite fiber laminate plate is de-molded (removed) from the caul plate. At 1070, the composite fiber laminate is then cut to a desired size. The cut composite fiber laminate may be subjected to any final processing (post-curing) steps as may be desired such as: machining to a different profile, grinding, or polishing. After the curing, demolding, and final processing, the laminate plate is ready for bonding to the steel core. At step 1080, bonding material is applied to the core armor plate on at least one of the strike face and the back face. Then at step 1090, the composite fiber laminate plate is placed on at least one of the strike face and the back face of the core armor plate.

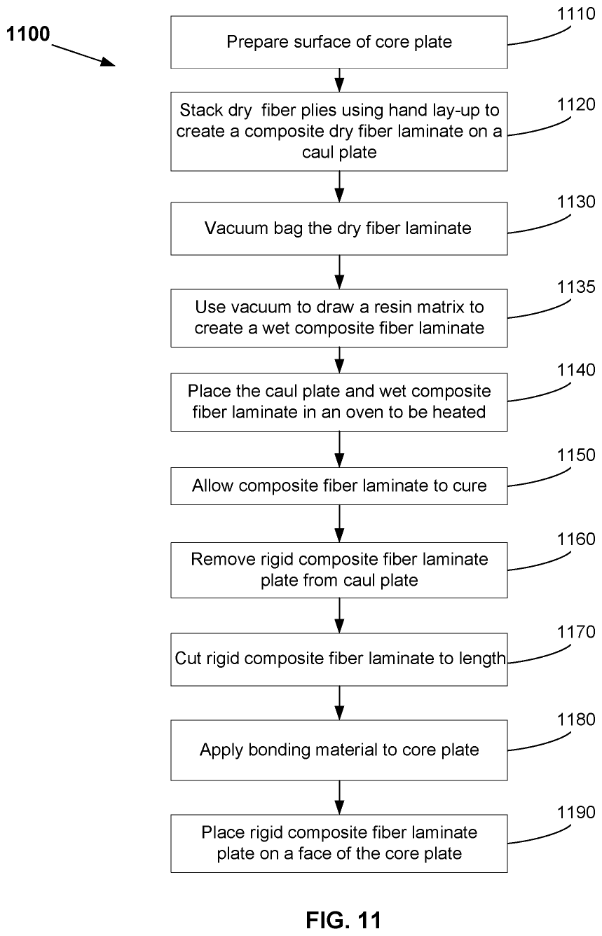

FIG. 11 depicts the steps of a process 1100 for reinforcing an armor by composite layering, in accordance with an embodiment of the current disclosure. In this process, the composite fiber laminates are cured independent of the core armor plate. At step 1110, the surface of the core is prepared if necessary, as described before with respect to step 1010 of process 1000. At step 1120, a plurality of dry fiber plies are stacked on a metal caul plate as described above with respect to step 1020 of process 1000, but in this case creating a dry fiber laminate. At step 1130, the dry fiber laminate is vacuum bagged to remove excess air. At step 1135, vacuum is used to draw a resin matrix into the dry fiber laminate thus creating a wet composite fiber laminate. Steps 1140, 1150, 1160, 1170, 1180, 1190 are identical to steps 1040, 1050, 1060, 1070, 1080, 1090 of FIG. 10.

In addition, the following modifications may be made to the process to incorporate desired properties: the fiber angle can be changed to tailor the final properties and/or to provide different performance characteristics and plate properties, including modulus and tensile strength; the laminate plate may have flat or curved features; and the laminate plate may utilize different composite fibers in different layers to tailor properties. Selected fibers should be of the highest quality and exhibit high strength and modulus characteristics, and be small in diameter (<100 micrometers—whereby fiber tensile strength increases with decreasing fiber diameter) and essentially defect free (probability of defects decreases with lower fiber diameter).

Tests have shown that composite-reinforced steel armor made in accordance with the described processes has been demonstrated to meet or exceed the mass and geometric constraints of existing steel armor solutions while meeting and exceeding impact protection standards and improving upon the weight and cost, and other parameters of a corresponding steel armor plate.

The reinforced armor described herein offers varying levels of protection through the ingestion and dissipation of kinetic energy from small-caliber armor piercing projectiles or equivalent impact hazards. The armor plate also offers a level of modularity as it can be used for body armor, vehicle armor and stationary armor applications. The final deliverable may be used as both vehicle mounted plate, or as a static or man-portable/body armor plate, such as in the form of a crowd control shield, semi-permanent barrier (such as for deployment from security checkpoints, in mine drill-and-blast sites, or for combat medics in need of mobile cover for rendering aid), or body vest. The extent and type of protection against different impact related threats varies depending on material choice, thickness and threat reduction application. For example varying the number of composite fiber plies, varying the materials in each ply, and varying the fiber orientation angles all provide for different types of armor suited for different applications. For example, a milling machine operator may encounter the same type of kinetic threat from high speed tooling failure or errant particle discharge during the metal machining process. Less lethal forms of harm are beneficiaries of improvements in impact resistance, including such diverse applications as shielding from construction debris, and protection against chain reactions because of multi-stage rocket plumbing failures.

The above-described embodiments are intended to be examples of the present disclosure and alterations and modifications may be effected thereto, by those of skill in the art, without departing from the scope of the invention, which is defined solely by the claims appended hereto.

1. A reinforced armor, comprising:
a core structure having a strike face and a back face;
a first composite fiber laminate, comprising a first plurality of composite fiber plies, bonded to the strike face of the core structure; and
a second composite fiber laminate, comprising a second plurality of composite fiber plies, bonded to the back face of the core structure;
wherein each composite fiber ply of the first and second plurality of composite fiber plies is comprised of a fibrous material impregnated with a matrix material; and
wherein the first composite fiber laminate has a smaller thickness than the second composite fiber laminate.

2. The reinforced armor according to claim 1, further comprising a first bonding layer between the first composite fiber laminate and the strike face of the core structure, and a second bonding layer between the second composite layer and the back face of the core structure.

3. The reinforced armor according to claim 2, wherein the first bonding layer and the second bonding layer each comprises an adhesive selected from the group consisting of: epoxy resin adhesive, urethane adhesive, film adhesive, and liquid adhesive paste.

4. The reinforced armor according to claim 1, wherein the core structure comprises a core plate made from a material selected from the group consisting of: steel, ceramic, titanium, silicon carbide, metal matrix composites, cermets, polymer matrix composites, and Inconel alloys.

5. The reinforced armor according to claim 4, wherein the steel is selected from the group consisting of: abrasion resistant (AR) steel, stainless steel, mild steel, and duplex stainless steel.

6. The reinforced armor according to claim 4, wherein the ceramic is one of: alumina, silicon nitride, boron nitride, porcelain, and silicon carbide.

7. The reinforced armor according to claim 1, wherein at least some composite fiber plies of the first and second plurality of composite fiber plies are oriented at different orientation angles relative to a latitudinal axis of the core structure.

8. The reinforced armor according to claim 7, wherein the different orientation angles vary between 0 and +/−90 degrees.

9. The reinforced armor according to claim 1, wherein the second plurality of composite fiber plies has more composite fiber plies than the first plurality of composite fiber plies.

10. The reinforced armor according to claim 1, wherein at least one of the first and second plurality of composite fiber plies comprises composite fiber plies comprising different types of fibrous materials.

11. The reinforced armor according to claim 1, wherein the matrix material comprises: a polymer resin selected from the group consisting of: epoxy resin, vinyl ester, and Polydicyclopentadiene (PDCPD).

12. The reinforced armor according to claim 1, wherein the fibrous material is one of:
fiberglass, carbon fiber, aramid fiber, plastic fiber, and metallic fiber.

13. The reinforced armor according to claim 1, wherein the core structure comprises:
a first core plate having a second strike face and a second back face;
a central composite fiber laminate having a third strike face bonded to the second back face of the first core plate, and having a third back face; and
a second core plate having a fourth strike face bonded to the third back face of the central composite fiber laminate, and having a fourth back face.

14. The reinforced armor according to claim 1, wherein the core structure comprises a core plate having a plurality of perforations.

15. The reinforced armor according to claim 14, wherein the plurality of perforations are filled with one of: an elastomer, an adhesive, epoxy resin, and PDCPD.

16. A process for reinforcing an armor by composite layering, comprising:
stacking a plurality of composite fiber plies using hand lay-up to create a first wet composite fiber laminate and a second wet composite laminate;
placing the first wet composite fiber laminate on a first surface of a core plate of the armor;
placing the second wet composite fiber laminate on a second surface of the core plate of the armor;
subjecting the first and second wet composite fiber laminates and the core plate to heating;
allowing the core plate and first and second wet composite fiber laminates to co-cure; and
cutting the first and second composite fiber laminates to a desired length, wherein the first wet composite fiber laminate has a smaller thickness than the second wet composite fiber laminate.

17. The process for reinforcing an armor according to claim 16, further comprising preparing the at least one surface of the core plate by at least one of: sandblasting, cleaning by a cleaning solvent, and applying an etchant.

18. The process for reinforcing an armor according to claim 16, wherein stacking the plurality of composite fiber plies comprises orienting the composite fiber plies at different orientation fiber angles.

19. A process for reinforcing an armor, comprising:
stacking a plurality of fiber plies, on a caul plate, using hand lay-up to create a first and second fiber laminates;
vacuum bagging the first and second fiber laminates;
placing the caul plate and first and second fiber laminate in an oven and heating the caul plate and the first and second fiber laminates;
curing the first and second fiber laminates to form a first and second rigid fiber laminate plates;
demolding the first and second rigid fiber laminate plates from the caul plate, and cutting each plate to a desired length;
applying bonding material to a first and second surface of a core plate of the armor; and
placing the first and second rigid fiber laminate plates on a first and second surfaces respectively for bonding thereto,
wherein the first rigid fiber laminate has a smaller thickness than the second rigid fiber laminate.

20. The process for reinforcing an armor according to claim 19, wherein:
each ply of the plurality of fiber plies comprises a fibrous material impregnated with a matrix material;
each fiber laminate comprises a wet composite fiber laminate; and
each rigid fiber laminate plate comprises a rigid composite fiber laminate plate.

21. The process for reinforcing an armor according to claim 19, wherein:
each ply of the plurality of fiber plies comprises a dry fibrous material;
each fiber laminate comprises a dry fiber laminate;
each rigid fiber laminate plate comprises a rigid composite fiber laminate plate; and
wherein the process further comprises using vacuum to draw a resin matrix into the dry fiber laminate to create a wet composite fiber laminate, prior to placing the caul plate and the wet composite fiber laminate in the oven.

22. The process for reinforcing an armor according to claim 19, further comprising preparing at least one surface of the core plate by at least one of: sandblasting, cleaning by a cleaning solvent, and applying an etchant.

23. The process for reinforcing an armor according to claim 19, further comprising at least one of: cutting, machining, grinding, and polishing of each rigid fiber laminate plate prior to bonding the rigid fiber laminate plate to the core plate.

24. The process for reinforcing an armor according to claim 19, wherein stacking the plurality of composite fiber plies comprises orienting the composite fiber plies at different orientation fiber angles.
